(19) United States
(12) Patent Application Publication
(10) Pub. No.: US 2003/0161669 A1
(43) Pub. Date: Aug. 28, 2003

(54) Sheet postprocessing apparatus and image forming apparatus

(75) Inventors: Kenichiro Isobe, Shizuoka-ken (JP); Yasuyoshi Hayakawa, Shizuoka-ken (JP); Takashi Kuwata, Shizuoka-ken (JP); Masayoshi Fukatsu, Shizuoka-ken (JP); Junichi Sekiyama, Shizuoka-ken (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/372,776

(22) Filed: Feb. 26, 2003

(30) Foreign Application Priority Data
Feb. 28, 2002 (JP) 2002-053053
Feb. 10, 2003 (JP) 2003-032171

(51) Int. Cl. G03G 15/00

(52) U.S. Cl. 399/408

(57) ABSTRACT

The present invention relates to a sheet processing apparatus having a stapling means disposed detachably for stapling to conveyed sheets, the stapling means being movably supported between an operation position for stapling conveyed sheets and a replacement position for detaching the stapling means from the apparatus, the stapling means comprising; a connection portion connected to the apparatus for receiving a control signal from the apparatus; a cable for transmitting the control signal from the connection portion to the stapling means; and an urging means for urging the cable toward the inner side of the stapling means.

### BACKGROUND OF THE INVENTION

1. Field of the Invention

This invention relates to a sheet processing apparatus and an image forming apparatus having the sheet processing apparatus and, more particularly, to a sheet processing apparatus avoiding occurrence of clamping wires for a staple holder and an image forming apparatus having the sheet processing apparatus.

2. Description of Related Art

Image forming apparatuses such as printers may conventionally have a sheet processing apparatus in which plural sheets on which images are formed or printed are subject to a processing such as stapling upon aligning each end properly to perform such a processing on the sheets to be delivered. As such a sheet processing apparatus, a known type disposed on a side surface on a sheet delivery outlet of an image forming apparatus, has a structure that sheets printed in the image forming apparatus are fed sheet by sheet from the delivery outlet and aligned at the each end to deliver the sheets upon processing.

A stapling mechanism section is generally disposed inside the housing of the sheet processing apparatus. A widely known type has a structure that the housing lid is opened to handle paper jamming at the stapling mechanism section in the apparatus interior, to replace staples, and to replace the staple mechanism section, at times of occurrences of paper jamming at the stapling section, replacements of stapling, and malfunctions of the stapling mechanism section.

With these sheet processing apparatuses having such a stapling function, however, users have to laboriously open the housing lid to handle paper jamming or staple replacement through the stapling mechanism section located at the interior of the apparatus when paper jamming occurs or staple replacement is required at the staple section because the staple mechanism section is disposed at the inner side of the housing of the sheet processing apparatus. The users therefore have to go through a large number of actions during handling of paper jamming or staple replacement, and are subject to bad maneuverability as processing on the internal apparatus located inside the housing. These apparatuses also have disadvantages such that the apparatuses become structurally complicated as the apparatus housing is formed with the lid and thereby increase the costs.

A structure has been recently devised in which users can handle unit replacement properly during paper jamming processing, staple replacement or malfunction of the stapling section upon moving the unit directly in the accessing direction, where a housing of a unit of the staple mechanism section also serves as the outer housing of the sheet processing apparatus, and where the unit is movable and detachable from the sheet processing apparatus.

With such a structure, however, the staple unit or stapler requires a detachable connector cable where the power source of the stapler is supplied from the side of the sheet processing apparatus. The connector cable is prepared to have a longer length than the necessary length in consideration of handling easiness, but the cable may be clamped between the housing of the staple holder and the apparatus when the stable holder is moved, attached or detached, or namely, so-called “wire clamping” may occur.

### SUMMARY OF THE INVENTION

It is an object of the invention to prevent lime clamping of the cable for a staple holder. To accomplish the above object, a representative structure of the invention is of a sheet processing apparatus having a stapling means disposed detachably for stapling to conveyed sheets. The stapling means takes an operation position for stapling processing to a conveyed sheet and a replacement position for detaching the stapling means from the apparatus. The stapling means includes a connection portion connected to the apparatus for receiving a control signal from the apparatus, a cable for transmitting the control signal from the connection portion to the stapling means, and an urging means for urging the cable toward the inner side of the stapling means.

With this invention, thus, the stapling means has the urging means for urging the cable toward the inner side of the stapling means, and therefore, the cable of the stapling means is pulled inside the stapling means, so that wire clamping in which the cable is clamped between the stapling means and the apparatus is avoided.

### BRIEF DESCRIPTION OF THE DRAWINGS

FIG. 1 is a schematic cross section showing the whole structure of a sheet processing apparatus and an image forming apparatus;

FIG. 2 is a cross section showing a delivery roller and the sheet processing apparatus;

FIG. 3 is a cross section showing a sheet processing apparatus;

FIG. 4 is an illustration showing operation of a sliding guide;

FIG. 5 is an illustration showing operation of the sliding guide;

FIG. 6 is an illustration showing a state in which sheets are aligned and stacked with the sliding guide;

FIG. 7 is a perspective view showing a printer to which the sheet processing apparatus is mounted;

FIG. 8 is an illustration showing a structure of a staple holder;

FIG. 9 is a right side view showing the sheet processing apparatus;

FIG. 10 is a top view showing the sheet processing apparatus with movement of the stapler;

FIG. 11 is a perspective view showing the sheet processing apparatus with movement of the stapler;

FIG. 12 is an illustration of operation when a staple holder is removed;

FIG. 13 is a perspective view showing the sheet postprocessing apparatus with movement of a paper jam treating housing;

FIG. 14 is an illustration showing a movement of operation control switch and the vicinity;

FIG. 15 is a perspective view showing the sheet postprocessing apparatus when the staple holder is removed;

FIG. 16 is a perspective view showing a staple holder in the first embodiment;

FIG. 17 is a perspective view showing the staple holder while removed in the first embodiment;

FIG. 18 is a perspective view showing the staple holder while removed in the second embodiment;

FIG. 19 is a perspective view showing the staple holder at the operation position in the second embodiment;

FIG. 20 is a perspective view showing the staple holder while removed in the third embodiment; and

FIG. 21 is a perspective view showing the staple holder at the operation position in the third embodiment.

### DETAILED DESCRIPTION OF THE PREFERRED EMBODIMENTS

Referring to the drawings, the embodiments of the invention are described in detail. In the following embodiments, exemplified is a sheet processing apparatus mounted to a printer apparatus as represented by a laser beam printer.

[First Embodiment]

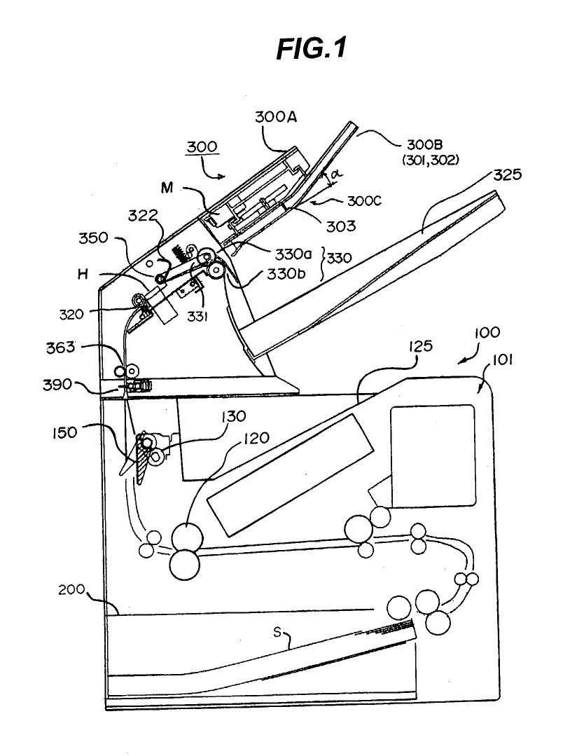

First, referring to FIG. 1 to FIG. 6, structures of a printer body and a sheet processing apparatus, a series of operations in the first embodiment are described. FIG. 1 is a schematic cross section showing the whole structure of a sheet processing apparatus and an image forming apparatus.

In FIG. 1, numeral 100 indicates a printer body, which is solely coupled to a computer or coupled to a network such as a LAN or the like, and which forms images on sheets with a prescribed image forming process based on image information transmitted from the computer or the network and a print signal and delivers the printed sheets.

In a meantime, the sheet processing apparatus 300 is an apparatus that stacks, on a first sheet stacking portion, sheets delivered from the printer 100 to the exterior thereof via a conveyance portion in the sheet processing apparatus as facing down state in which the image side is placed downward, aligns the sheets with the aligning means, and delivers on the stacking portion 325 of the sheet processing apparatus the stacked sheets upon stapling the sheets at a single or plural portions of the sheets where the sheets are bundled at each prescribed job, or delivers sheets as facing down on the stacking portion 325 of the sheet processing apparatus.

The sheet processing apparatus 300 and the printer body 100 are electrically coupled with a cable connector not shown. The sheet processing apparatus 300 has a housing 300A for containing each part and is detachably attached to an apparatus body 100A of the printer body 100 as described below.

Each structure of portions of the printer body 100 is described along the conveyance path at of the sheet S to be conveyed. In the printer 100, plural sheets S are stacked in a feeding cassette 200, and various rollers separately conveys the topmost sheet one by one among the plural sheets. According to a prescribed printer signal fed from the computer or the network, toner images are transferred to the sheets S fed from the feeding cassette 200 on a top side of the sheets at an image forming section 101 for forming toner images by an image forming process of a so-called laser beam type in the printer body 100, and subsequently, are permanently fixed upon application of heat and pressure at a fixing unit 120 located on a downstream side.

The sheet S to which images are fixed is turned to reverse the image side by being returned through a sheet conveyance path curving in a substantially letter U shape reaching to delivery rollers 130 as shown in FIG. 1, and is delivered as facing down to the exterior from the printer body 100 by the delivery roller 130 in a state that the image side faces down. The sheet S is selected to be delivered either to a face-down (FD) delivery portion 125 mounted on a top of the printer body 100 or to the stacking portion 325 of the sheet processing apparatus 300 according to the determination of the position of a flapper 150 in the printer 100 based on the control signal from the controller, not shown.

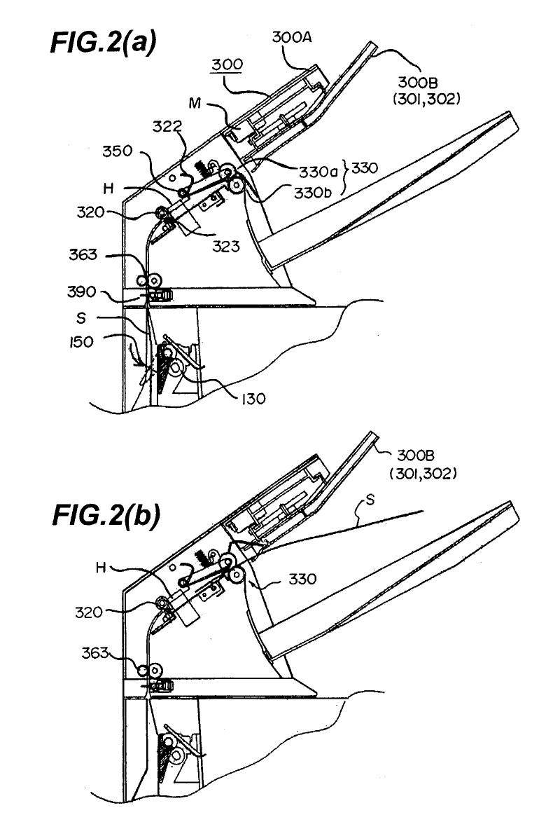

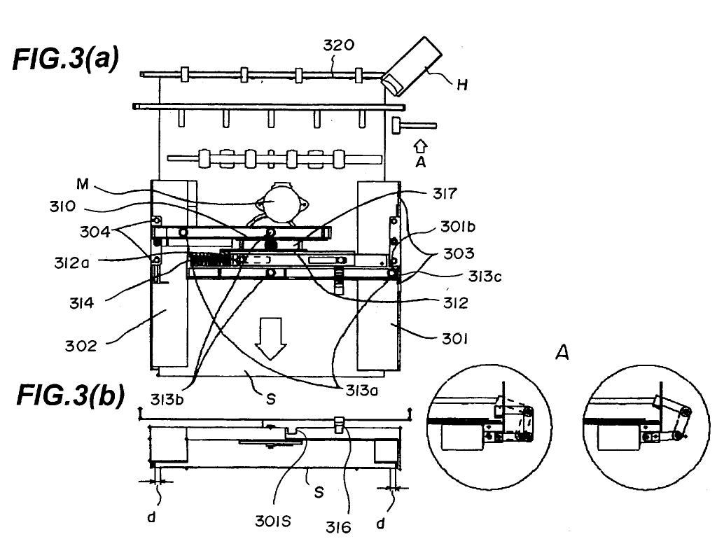

Then, the structure of the sheet processing apparatus, and motions of the respective portions when the sheet conveyed from the delivery roller 130 moves toward the sheet processing apparatus 300, are described in reference with FIG. 2 and FIG. 3. Herein, FIG. 2 is a cross section of the delivery roller and the sheet processing apparatus; FIG. 3 is a cross section of the sheet processing apparatus.

In FIG. 2, numeral 330a indicates a delivery upper roller, and numeral 330b indicates a delivery lower roller. Numeral M is a jogger motor as a drive source; numeral 322 indicates a paddle; numeral 323 is a reference wall for hitting the sheet rear end. As shown in FIG. 2, the delivery roller pair 300 structured of the delivery upper roller 330a and the delivery lower roller 330b is disposed upwardly on a downstream side of the flapper 150 described above in the sheet conveyance direction and driven to rotate by a drive motor, not shown.

The delivery upper roller 330a is supported at the axis thereof to an arm 331 pivotally movable around a paddle shaft 350 as a center. The jogger motor M is for driving respective sliding guides 301, 302 described below, and in this embodiment, a stepping motor is used.

The paddle 322 is made of an elastic material such as a rubber or the like, and plural paddles 322 are secured to the paddle shaft 350 in a direction perpendicular to the sheet conveyance direction. The sheets S are moved to a direction in opposition to the sheet conveyance direction by driving and rotating the paddle shaft 350 in a clockwise direction, and the end face of the sheets S comes in contact with the reference wall 323 to align the sheets S.

As shown in FIG. 3, with the sheet processing apparatus 300 in this embodiment, the sliding guide R301 and the sliding guide L302 are formed as described below in detail as a guide member for aligning the sheets in the sheet width direction.

In the sheet processing apparatus 300, when stapling is performed based on a command already outputted from the computer or the like, the flapper 150 moves pivotally in the counterclockwise direction in FIG. 2 by a link, not shown, from a solenoid, not shown, before the sheet S to be stapled is delivered by the delivery roller 130, and the sheet path is switched to the sheet processing apparatus 300 where the flapper 150 stops as in contact with the stopper at the position shown in FIG. 2(a). The sheet S is thus loaded to an inlet sensor 390 of the sheet processing apparatus 300 by a roller pair formed at the printer body 100.

The sheet S loaded in the sheet processing apparatus 300 rotates a flag of the inlet sensor 390 in the clockwise direction, and the flag renders the beam transmit to the photo sensor to make the detection. Then, the inlet roller pair 363 conveys the sheet upward.

This sheet processing apparatus 300 can deliver the sheets in a stacking manner on the stacking portion 325 of the sheet processing apparatus upon stapling the sheets and can deliver the sheets in a stacking manner on the stacking portion 325 of the sheet processing apparatus as simply facing down, as well. First, as shown in FIG. 2, the operation for delivering sheets in a stacking manner on the stacking portion 325 of the sheet processing apparatus, is described.

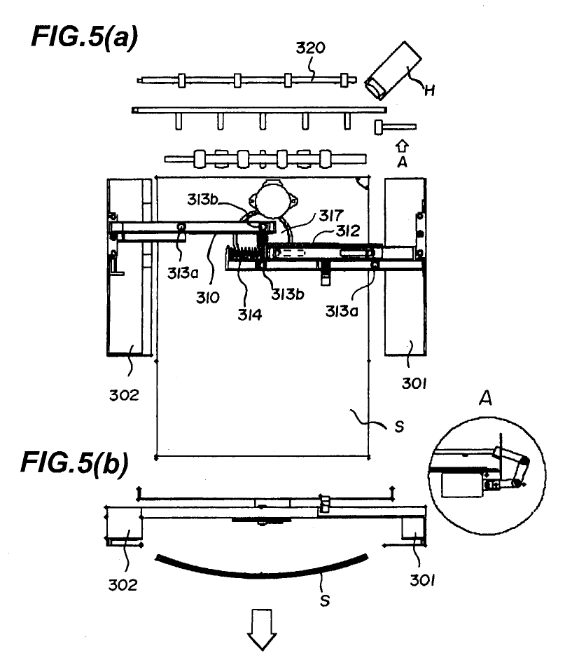

At that time, as shown in FIG. 5, the bottom surfaces of the right side sliding guide R301 and the left side sliding guide L302 with respect to the sheet loading direction, escape to a position not in contact with the sheets S to be loaded, or namely, to a position outward in the width direction by a prescribed amount from the sheet S, and therefore, the sheets S are directly conveyed to the stacking portion of the sheet processing apparatus.

The sheet conveyed from the inlet roller pair 363 is conveyed by the delivery roller pair 330 upon passing the opening of the staple H after passing through a staple roller pair 320 and stacked on a staking portion 325 of the sheet processing apparatus.

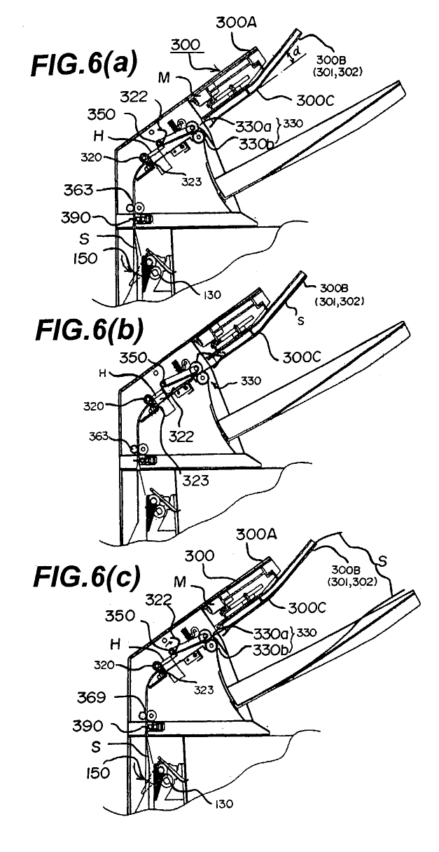

Next, referring to FIG. 6, operation to deliver the sheets in a staking manner on the stacking portion 325 of the sheet processing apparatus upon stapling is described.

At that time in the sheet processing apparatus 300, as shown in FIG. 3(a), a reference pin R303 and a reference pin L304 formed at the wall surfaces of the right side sliding guide R301 and the left side sliding guide L302 with respect to the sheet loading direction, escape to a position not in contact with the sheets S to be loaded so as not to interfere with the sheets S to be loaded. The interval between the end of the bottom surfaces of the sliding guides is narrower than the width of the sheet, and the sliding guides wait the entry of the sheets S. This position is called to as a waiting position.

The sheet conveyed from the inlet roller pair 363 is conveyed by the delivery roller pair 330 upon passing the opening of the staple H after passing through a staple roller pair 320 onto a guide surface of an intermediate stacking portion 300B made of the sliding guide R301 and the sliding guide L302.

The guide surface of the intermediate stacking portion 300B is slanted by a prescribed angle with respect to the horizontal direction as shown in FIG. 6(a), and has slanted angles different to each other between the upstream side and the downstream side in the sheet loading direction. More specifically, a bending section 300C bending with a slanted angle alpha (see FIG. 1) is formed between a prescribed section on an upstream side and a prescribed section on a downstream side. The guide surface of the intermediate stacking portion 300B prevents the sheets S not guided by the respective sliding guides 301, 302 from bending at the center, by having such a bending portion 300C.

Immediately after the first sheet is conveyed onto a surface made of the sliding guide R301 and the sliding guide L302, the arm 331 rotates in the counterclockwise direction to escape upward the delivery upper roller 330a rotatably supported to the arm 331, thereby isolating the delivery roller pair 330, and at the same time, cutting the drive coupled to the delivery roller pair 330 to stop the rotation of the delivery upper roller 330a and the delivery lower roller 330b. When the rear end of the sheet S passes by the staple roller pair 320 totally, the sheet returns by the self-weight in a direction opposition to the conveyance direction and moves closer to a direction of the reference wall 323.

Subsequently, upon operation solely of the left side sliding guide L302, aligning operation in the width direction begins for respective sheets stacked on the intermediate stacking portion 300B. More specifically, the sliding guide L302 is driven by the motor M to move on a right side in FIG. 3, thereby rendering the reference pin L304 formed at the sliding guide L302 contact with the left side surface of the sheet S to push the sheet S toward the sliding guide R301.

The right side surface of the sheet S then hits the reference pin R303 formed at the sliding guide R301, and thereby alignment in the width direction of the sheets is made. It is designed that the sheets S move to a stapling position defined at a position where the sheets S contacts the reference pin R303 and are aligned. After the alignment operation, the sliding guide L302 moves to a direction expanding the width of the sheet S, and the apparatus become responsible to the subsequent conveyance of the sheet at the waiting position.

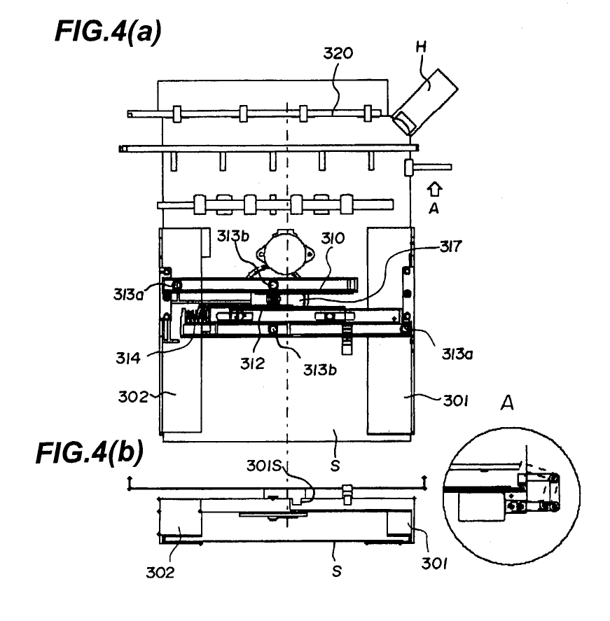

The structure of the sliding guide is now described in detail. FIG. 3 is a cross section of the sheet processing apparatus; FIG. 4 and FIG. 5 are illustrations for describing operation of the sliding guide.

The respective sliding guides 301, 302 are reciprocally movable in a right and left direction in FIG. 3, or a direction perpendicular to the sheet conveyance direction by being guided with the guide pins 313a formed at the molded frame and the guide pins 313b formed at the metal plate frame, four in total, and move according to transmission of the drive force of the jogger motor M.

The sliding guides 301, 302 are in a cross-sectionally rectangular U-shape as shown in FIG. 3(b) when seen from the downstream side of the sheet conveyance direction, by respective walls for guiding each edge of the sheet S and a supporting portion for supporting the up and down sides of the sheet S. The sliding guides 301, 302 has a structure to support the respective sheets delivered onto the intermediate stacking portion 300B by the lower surface of the rectangular U-shape and not to guide the center in the width direction of the sheet.

A sliding rack portion L310 having a planer gear meshing a stepwise gear 317 is formed at the sliding guide L302. In a meantime, a sliding rack portion R312 having a planer gear meshing a stepwise gear 317 is formed at the sliding guide R301. The sliding rack portion R312 is formed as to be movable correlatively to the sliding guide R301 via a coil spring 314. The spring 314 has an end in contact with the sliding guide R301 and the other end in contact with the sliding guide R312 and is urging the sliding guide R301 and the sliding rack R312 in an expanding direction. The sliding rack R312 has a rectangular hole 312a for moving an embossing portion 301a on a side of the sliding guide R301.

The two reference pins R303 made of a metal excellent in resisting wearing are formed on a side wall of the sliding guide R301, and the two reference pins L304 are formed on a side wall of the sliding guide L302. When sheets are aligned, the sliding guide L302 moves as described below to contact the reference pin L304 and the reference pin R303 with respective edges of the sheet. The sliding guide R301 and the sliding guide L302 are supported in the height direction by the stepwise gear 317 and the jog metal plate frame. The stapler H is stationally disposed on a side of the sliding guide R301 to staple the respective sheets at the left upper corner of the image side of the image-formed sheets.

Referring to FIG. 3 to FIG. 5, operation of the sliding guides 301, 302 is described. When the sheet processing apparatus 300 is turned on, the stapling roller pair 320 driven by the drive motor begins rotating, and then, as the jogger motor M rotates to rotate the stepwise gear 317, the sliding rack L310 of the sliding guide L302 is driven to escape outwardly. With the sliding guide R301, when the jogger motor M rotates to rotate the stepwise gear 317, the sliding rack R312 correlatively moves, and after the rectangular hole 312a of the sliding rack R312 contacts to the end on a right side in FIG. 3 of the embossing portion 301a of the sliding guide R301, the sliding guide R301 is pushed by the rectangular hole 312a and escapes outwardly.

A slit portion 301S is formed at the sliding guide R301. When the slit portion 301S moves to a prescribed escaping point, the photo sensor 316 passes a beam, and the jogger motor M stops at that time. This position is defined as a home position.

When a signal for entering the sheet S to the sheet processing apparatus 300 is inputted from the printer body 100 to the sheet processing apparatus 300, the jogger motor M rotates, and the sliding guide R301 and the sliding guide L302 move inside and stop at positions wider by a prescribed amount than the width of the entering sheet S. The sliding guide R301 at that position enters in a state not movable further inward whereas the stopper 301b contacts with the end face 313c of the guide pin 313a. This position shown in FIGS. 3(a), 3(b), is defined as a waiting position, and this waiting position becomes a reference position when the side surface of the sliding guide R301 is performing for alignment.

In this embodiment, when the size (or width) of the sheet S is the largest size that is able to make passage, the waiting position of the sliding guide R301 and the sliding guide L302 is set to have a space on each end in the width direction to become a prescribed amount d on each end.

It is to be noted that when the sheets having a width narrower than that are aligned at the sheet processing apparatus 300, the sliding guide L301 moves on a right side by a portion corresponding to this, and thereby the space on the left side in FIG. 3 at the waiting position always becomes a prescribed amount d. Meanwhile, in this situation, the space between the sheet and the sliding guide L302 becomes wider than the prescribed amount d by a half of the narrowed width.

As shown in FIG. 4, after alignment is made in the lateral direction by the sliding guides 301, 302, both of the sliding guides escape a little outwardly, thereby rendering the regulation in the lateral aligning direction of the sheets in a rough state, and thereby rendering the sheets S movable in the sheet conveyance direction. Subsequently, as shown in FIG. 6(b), the paddle 322 rotates one time in a clockwise direction around the paddle shaft 350 as a center and comes in contact with the top surface of the sheet S, thereby aligning the sheets S by hitting the sheets S to the reference wall 323.

Those operations make possible alignments in the sheet conveyance direction and in the direction perpendicular to the sheet conveyance direction. To keep this aligned state, as shown in FIG. 4, a stamping means 400 is provided near the right end of the aligned sheets for pushing the aligned sheets by moving a lever having a frictional member in the up and down direction as shown in cross section A, and the lever pushes the top side of the sheet after the alignment operation is finished but before the subsequently entered sheet hits the aligned sheets, thereby avoiding the subsequent sheet to move the aligned sheets.

In operation for the next and following sheets, when the next and further sheets are conveyed, the delivery roller pair 330 is isolated. Therefore, when the rear end of the sheet S totally passes through the staple roller pair 320, the sheet returns by the self-weight in a direction opposite to the conveyance direction and moves toward the reference wall 323. Because the following alignment operation is exactly the same as the operation for the first sheet, a description is omitted.

Such operations are repeated, and where the last (n th) sheet (Sn) of the one job is aligned, the respective reference pins L304 formed at the sliding guide L302 push the left side surface of the sheet to the respective reference pins R303 of the sliding guide R302, and stapling is made at a position of the rear end right side with a compact stapler H located on a rear end right side of the sheet bundle while the movement of the sliding guide L302 is stopped as shown in FIG. 4.

According to this structure and operation, during the alignment operation of the respective sheets, the sliding guide R301 stops and does not move at the reference position, and the sliding guide L302 solely moves to align the left side end of the respective sheets at the reference position, so that the stapling processing is accurately, surely performed by the stapler H stationally disposed on a side of the sliding guide R301. Moreover, even where the widths of the respective sheets loaded at one job are deviated, or where the sheet size is changed from, e.g., the LTR to the A4 in the one job, since the positions of the left ends of the sheets are aligned at a point, the stapling processing with the stapler H is finished accurately and beautifully, and an excellent advantage is obtained.

In the first embodiment, when the stapling is thus ended, as shown in FIG. 6, the arm 331 rotates in the clockwise direction to move the delivery upper roller 330a rotatively supported to the arm 331 downward, and drive is coupled to both rollers of the delivery roller pair 330 at the same time that the delivery roller pair 330 is formed, thereby rendering the delivery upper roller 330a and the delivery lower roller 330b begin to rotate.

With this operation, the bundle of the sheets S is nipped by the delivery upper roller 330a and the delivery lower roller 330b, and conveyed onto a surface made of the sliding guide R301 and the sliding guide L302.

When the bundle of the sheets S is completely delivered from the delivery roller pair 330, the jogger motor M drives to rotate, and thereby, the sliding guide L302 moves in an isolating direction from the state shown in FIG. 4. It is to be noted that when the sliding guide L302 begins rotating, in regarding the side of the sliding guide R301, sliding rack 312 moves to the right side in FIG. 4, and the sliding guide R301 itself does not move immediately.

When the position of the sliding guide L302 passes through the waiting position shown in FIG. 3, the rectangular hole 312a of the sliding rack 312 comes in contact with the end surface of the embossing portion 301a of the sliding guide R301, and the sliding guide R301 begins moving to the right side in FIG. 3, thereby moving both of the sliding guides 301, 302.

The bundle of the sheets S already stapled is dropped down as shown in FIG. 6(c) when the interval of the sliding guides 301, 302 for supporting the sheets becomes around the sheet width or wider. Thus, the sheet bundle drops to the stacking portion 325 of the sheet processing apparatus and is stacked.

The above description is the structure and a series of the operations of the printer body 100 and the sheet processing apparatus 330 in the first embodiment.

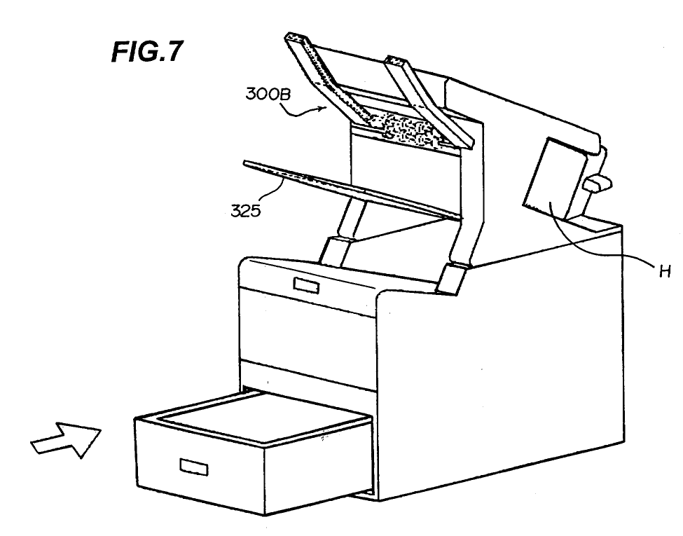

Next, referring to FIG. 7 to FIG. 14, a structure of a compact stapler H placed at a rear end right side of the sheet bundle in the first embodiment of the invention is described.

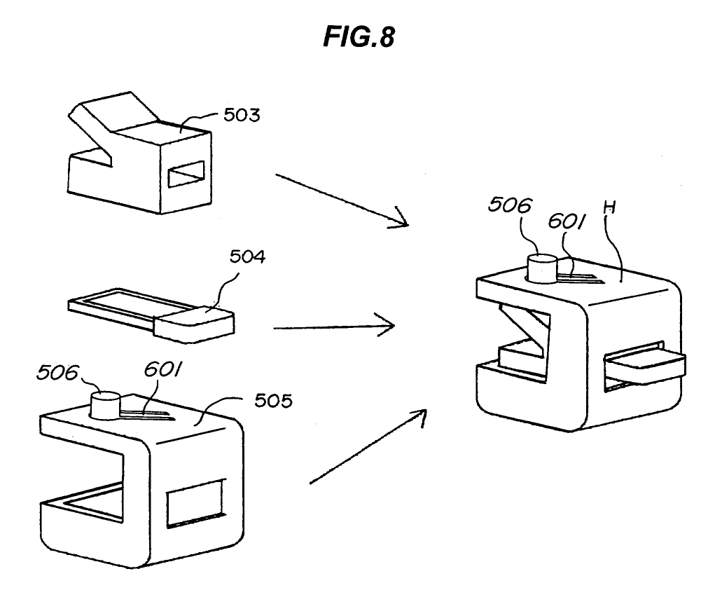

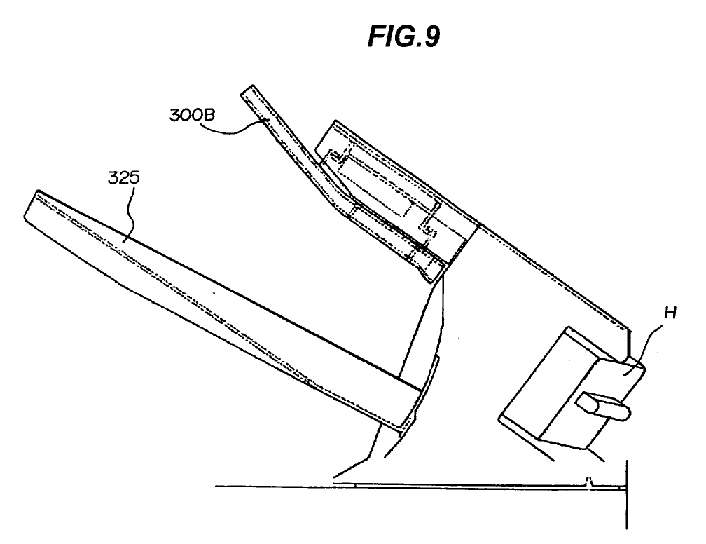

As shown in FIG. 8, the stapler H is structured of a stapler body 503, a staple cartridge 504, and a staple cover 505, as a staple holder H (stapling means). FIG. 9 is a right side view of the sheet processing apparatus in this embodiment. As shown in FIG. 9, the staple cover in the first embodiment also serves as a the outside of housing of the sheet processing apparatus.

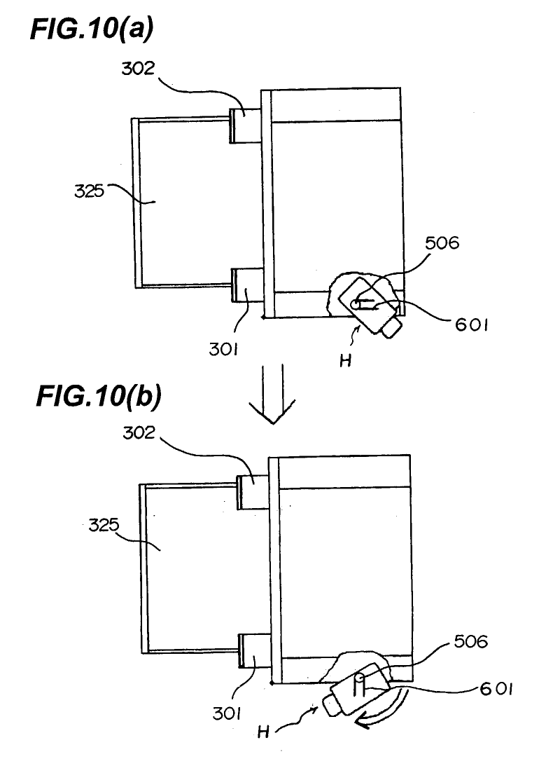

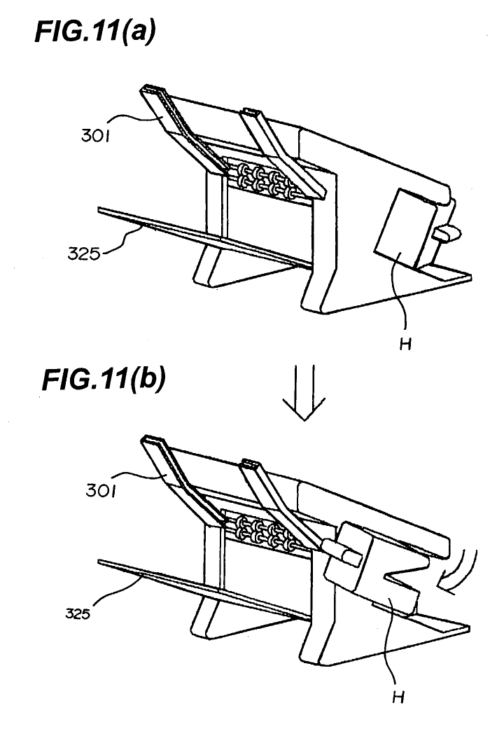

The staple holder in this embodiment is able to rotate around a shaft 506 as a center as shown in FIG. 10(a), FIG. 11(a). The staple holder is structured to hold staples with clicking feelings by a latch mechanism, not shown, at a staple operation position (see, FIG. 10(a) and FIG. 11(a), hereinafter referred to as staple operation position) and at a staple holder replacement position (see, FIG. 10(a) and FIG. 11(a), hereinafter referred to as staple holder replacement position).

Next, user's manipulation method when staples are stacked at the staple portion or when the staple portion becomes out of order, with the sheet processing apparatus of such a structure having a staple stacker function, is described.

As shown in FIG. 10 and FIG. 11, when staple stacking occurs at the staple portion or when the staple portion becomes out of order, the user directly moves the staple holder pivotally from the staple operation position to the staple replacement position around the shaft 506 as a center by hands. At that time the staple holder H is supported by a latch mechanism not shown at the staple operation position (a) with constant force, but the retaining force is released when the staple holder moves from the staple operation position (a) upon rotation by hands.

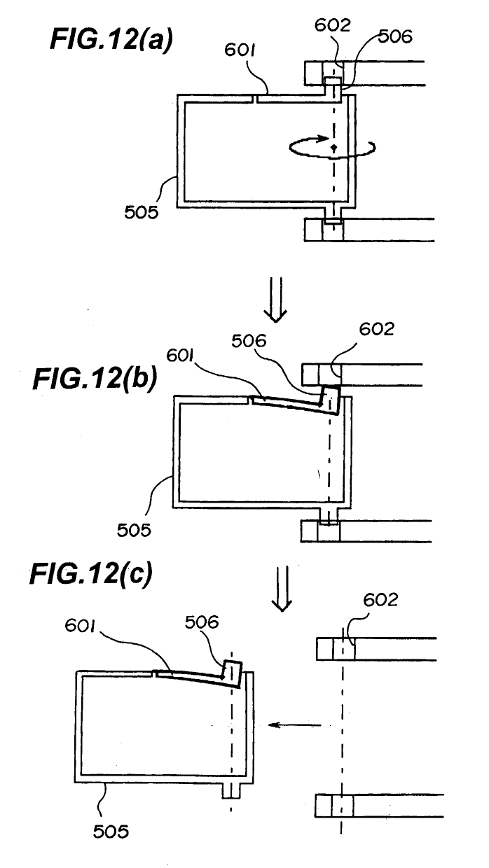

At the staple replacement position (b), as shown in FIG. 10(b), a projecting portion 601 including a rotary center shaft 506 located at a top of the staple holder enters in an exposed state. As shown in FIG. 12, the user can bend the projecting portion 601 by pushing a side of the projecting portion 601 from the above state and can pull out the rotary center shaft 506 from the shaft hole 602 formed in the sheet processing apparatus 300, thereby removing the staple holder H from the sheet processing apparatus. With this structure, the staple operation position (a) can improve the external appearance because the projecting portion 601 serving as the staple holding removing means is hidden.

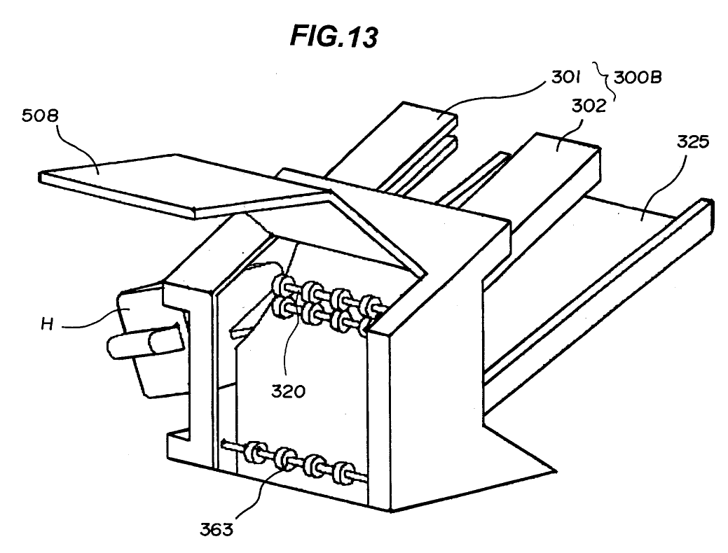

The sheet processing apparatus 300 in this embodiment is formed as shown in FIG. 13 with a paper jam treating cover (paper jam treating means) 508 for handling paper jamming at the conveyance portion. With this structure, the user may be mistakenly clamped by the staple from a malfunction because the stapling section of the stapler H is not covered during a paper jam treating period. As shown in FIG. 11, also at the staple replacement position (b), the user may be mistakenly clamped by the staple from a malfunction where the stapling section of the stapler H is exposed to the exterior.

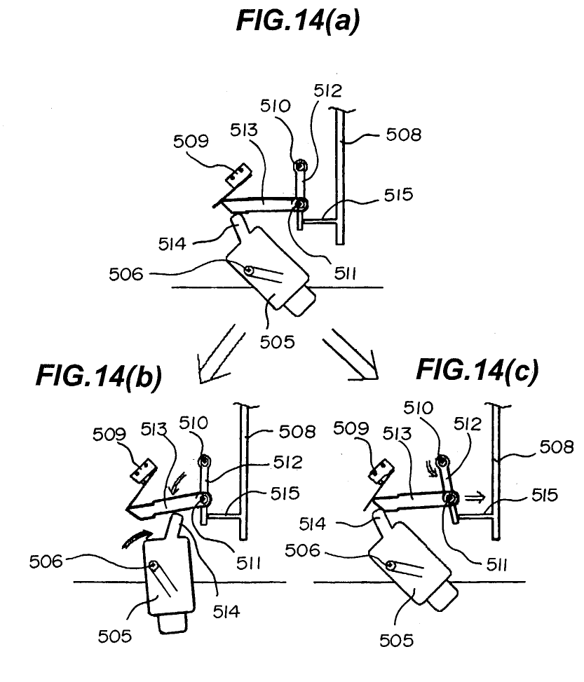

In this embodiment, as shown in FIG. 14, the apparatus is formed inside with an operation control switch 509 of the sheet processing apparatus, a link 512 for supporting a shaft 511 movable rotatably around a shaft 510, a link lever 513 pivotally movable around the shaft 511, a switch lever 514 formed at the staple cover 505, and a switch lever 515 formed at the paper jam treating cover 508.

As shown in FIG. 14(a), where the staple holder H is at the staple operation position (a) and where the paper jam treating cover 508 is at a closed position, the operation control switch 509 is turned on by the link lever 513 to make the sheet processing apparatus enter into an operable state.

Furthermore, as shown in FIG. 14(b), where the staple holder H is other than at the staple operation position (a), the operation control switch 509 is turned off because the link lever 513 pushed by the switch lever 514 of the stable cover 505 is moved pivotally, thereby making the sheet processing apparatus enter in a non-operable state. Therefore, the apparatus is designed so that, when the stapling section is exposed to the exterior at the staple replacement position (b), the user may not be clamped mistakenly with a staple by a malfunction.

As shown in FIG. 14(c), where the paper jam treating cover 508 is at an open position, the operation control switch 509 is turned off because the link lever 513 moves away from the operation control switch 509 by the link 512 pushed by the switch lever 515 of the paper jam treating cover 508 is moved pivotally around the shaft 512 as a center to move the shaft 511, thereby making the sheet processing apparatus enter in a non-operable state. Therefore, the apparatus is designed so that, when the stapling section of the stapler H is exposed upon opening of the paper jam treating cover 508, the user may not be clamped mistakenly with a staple by a malfunction.

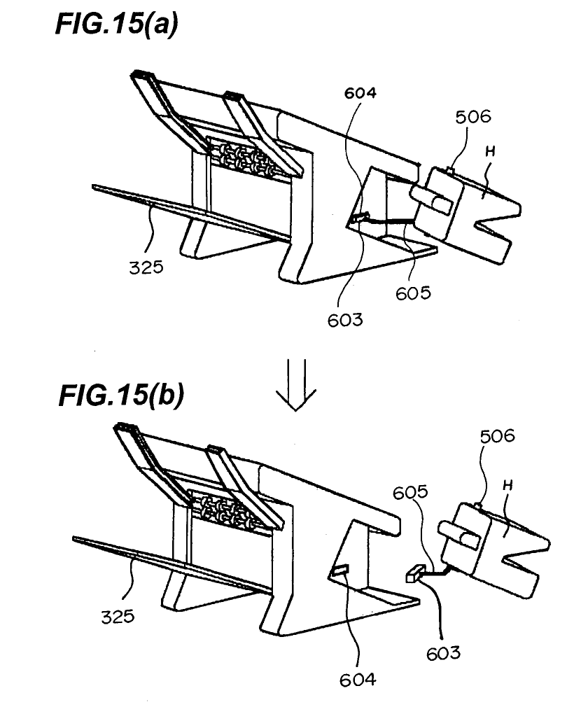

In this embodiment, the connector is necessarily taken out as shown in FIG. 15(b), because a cable connector (connecting portion) 603 coming out of the staple holder H and a connector 604 on a side of the sheet processing apparatus are coupled to each other at a time that the staple holder H is removed from the sheet apparatus processing as shown in FIG. 15(a). Similarly, when the staple holder is attached to the sheet processing apparatus, the staple holder is attached after the cable connector 603 is coupled, and the holder is returned to the staple operation position (a) upon moving pivotally from the staple replacement position (b).

With this structure, the cable 605 requires a longer length to some extent for coupling and uncoupling the connector while the holder is attached and detached. The cable 605 may be loosen to be bent during pivotal movement of the staple holder during the attachment of the staple holder, and the cable 605 may be clamped at a gap or the like between the staple holder and the sheet processing apparatus.

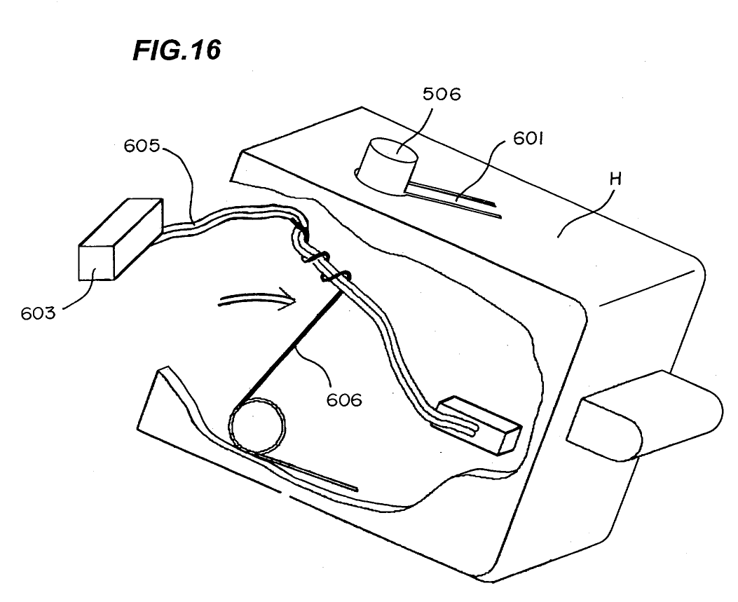

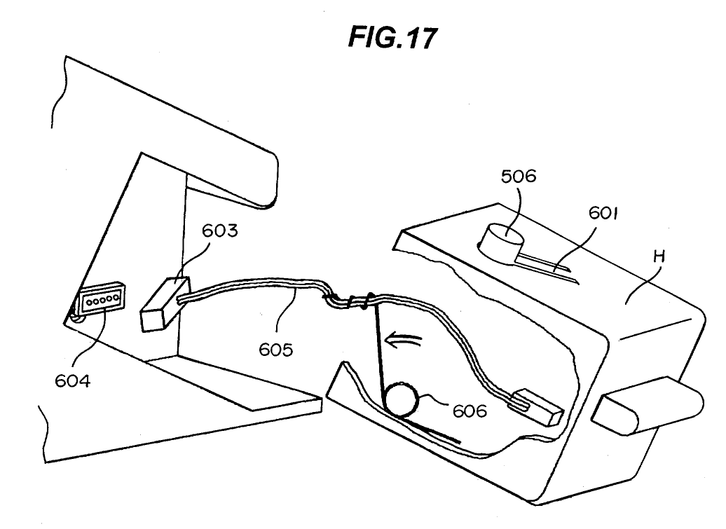

In this embodiment, as shown in FIG. 16, a wire spring 606 (urging means) is attached inside the staple holder H for pulling the cable 605 toward the interior of the staple holder upon securing a part of the cable 605. With this structure, while the connector is attached or detached, work is done upon pulling out the cable 605 in opposing the urging force of the wire spring 606 by pulling the connector 603 as shown in FIG. 17. The shaft 506 of the staple holder is then fitted into the shaft hole 602 (see, FIG. 12) of the sheet processing apparatus 300 as described above and is moved pivotally to allow the staple holder H to be attached. Where the staple holder H is brought closely to the sheet processing apparatus 300, the cable 605 is pulled in the staple holder H by urging force of the wire spring 606, so that the cable 605 exposed as bent during pivotal movement of the staple holder H may not be clamped between the staple holder H and the sheet processing apparatus 300.

It is to be noted that the wire spring 606 can be of a structure contacting an end of the wire spring 606 with the metal portion of the sheet processing apparatus when the staple holder H is attached to the sheet processing apparatus 300 where the attaching position of the wire spring 606 is selected properly. With such a structure, the wire spring 606 may be functioned as a ground for the stapler.

In the first embodiment, the apparatus thus constituted can make the staple holder H separate from the sheet processing apparatus with a simpler and more inexpensive structure than conventional apparatuses, so that controllability such as loading work and arrangement work of staples can be improved, and so that safety in work can be realized readily. Where the wire spring 606 is used as the urging means for the cable 605, clamping the cable 605 is avoided at a gap between the staple holder H and the sheet processing apparatus 300, which otherwise occurs due to a loosen cable 605 when the staple holder H is attached and moved pivotally, so that the connector is easily attached and detached.

[The Second Embodiment]

Next, a compact stapler H located on a rear end right side of the sheet bundle in the second embodiment of a sheet stacking apparatus according to this invention is described. Some description is omitted by assigning the same reference numbers to the same portions whose descriptions are repetitive of the first embodiment.

As described above, the connector 604 is necessarily disengaged because the cable connector 603 coming out of the side of the staple holder H and the connector 604 on a side of the sheet processing apparatus at a time when the staple holder H is removed from the sheet processing apparatus. Similarly, when the staple holder is attached to the sheet processing apparatus, the staple holder is attached after the cable connector 603 is coupled, and the staple holder is moved pivotally from the staple replacement position (b) and returned to the staple operation position (a).

With this structure, the cable 605 requires a longer length to some extent for coupling and uncoupling the connector 603 before or after work for attaching or detaching the staple holder. The cable 605 may be loosen to be bent during pivotal movement of the staple holder H when the staple holder H is attached to the sheet processing apparatus after the attachment of the cable connector 603, and the cable 605 may be clamped between the staple holder and the sheet processing apparatus.

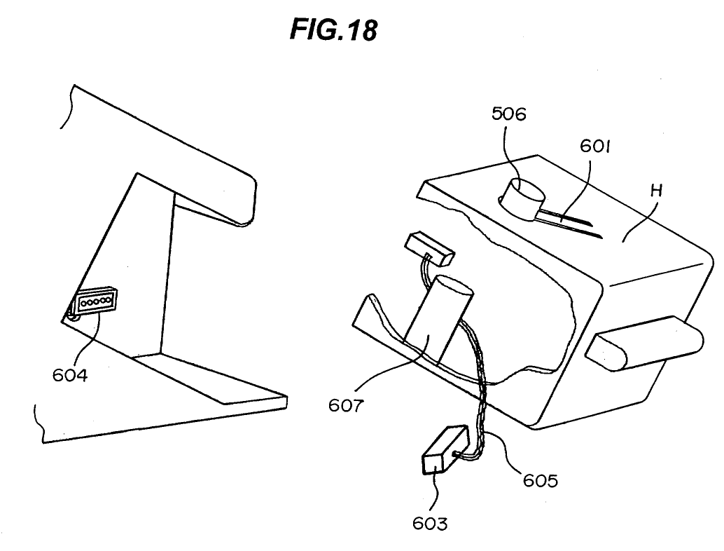

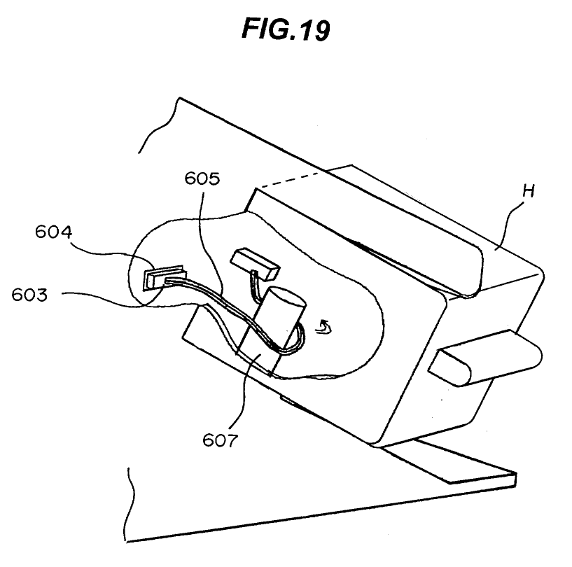

As shown in FIG. 18 and FIG. 19, in this embodiment, a bobbin (winding shaft) 607 for winding the cable is provided inside the staple holder for the cable 605. As shown in FIG. 18, while the connector is attached or detached, the cable 605 is unwound from the bobbin 607, and the loosen cable 605 is pulled out to make the connector attached or detached. As shown in FIG. 19, where the staple holder H is attached to the sheet processing apparatus 300 and moved rotatively, the cable 605 is wound around the bobbin 607 as the staple holder H rotates, thereby preventing the cable from being loosen to be exposed to the exterior. It is to be noted that a winding amount at a time of rotation can be increased as the bobbin 607 is placed away from the rotation center of the rotational shaft 506 of the staple holder H.

With this structure, in the second embodiment, the apparatus can realize improvements of controllability at a time of replacement work of the staple holder H in accompany with loading work of the staples and malfunctions of the staple section and safety in work with a simpler and more inexpensive structure than conventional apparatuses. Occurrence of clamping the cable is avoided at a gap between the staple holder and the sheet processing apparatus, which otherwise occurs due to a loosen cable when the staple holder H is moved pivotally.

[The Third Embodiment]

Next, a compact stapler H located on a rear end right side of the sheet bundle in the third embodiment of a sheet stacking apparatus according to this invention is described. Some description is omitted by assigning the same reference numbers to the same portions whose descriptions are repetitive of the first embodiment.

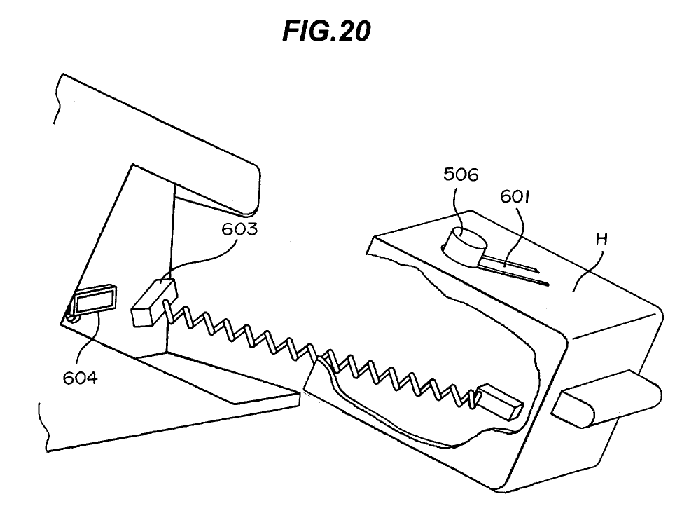

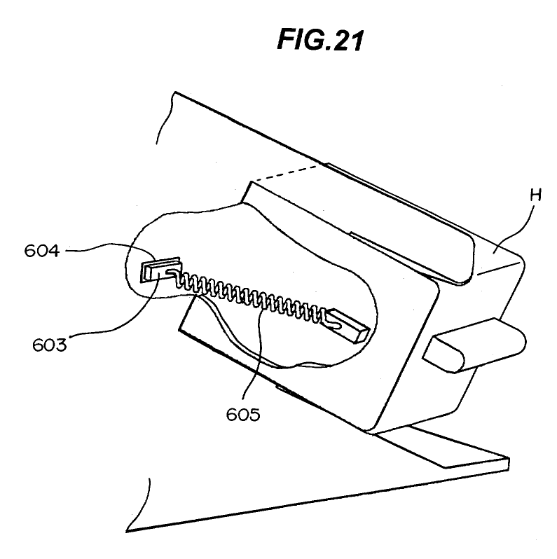

As shown in FIG. 20 and FIG. 21, in this embodiment, the cable 605 itself is structured as wound in a coil shape, enabling to be extendable by pulling one end of the cable. As shown in FIG. 20, with such a structure, the cable 605 wound in a spiral shape can be unwound and pulled out by pulling the connector 603 while the connector 603 is attached or detached to the sheet processing apparatus 300, thereby allowing the connector attaching and detaching work as the whole length of the cable 605 is extended. As shown in FIG. 21, when the staple holder H is attached to the sheet processing apparatus, the cable 605 is not clamped between the staple holder and the sheet processing apparatus during the rotation of the staple holder H, because the cable 605 is wound in a spiral shape to be short and does not become loosened as the staple holder H is placed closely to the sheet processing apparatus 300.

With such a structure, in the third embodiment, the apparatus can realize improvements of controllability at a time of replacement work of the staple holder H in accompany with loading work of the staples and malfunctions of the staple section and safety in work with a more inexpensive structure than conventional apparatuses. Occurrence of clamping the cable is avoided at a gap between the staple holder and the sheet processing apparatus, which otherwise occurs due to a loosen cable when the staple holder H is moved pivotally, so that the connector is attached and detached readily.

[Other Embodiments]

In the above embodiments, exemplified is a printer as an image forming apparatus, but the invention is not limited to this, and photocopiers and facsimile machines can be used.

What is claimed is:

1. A sheet processing apparatus having a stapling means disposed detachably for stapling to conveyed sheets,
the stapling means being movably supported between an operation position for stapling conveyed sheets and a replacement position for detaching the stapling means from the apparatus, the stapling means comprising:
connection portion connected to the apparatus for receiving a control signal from the apparatus;
a cable for transmitting the control signal from the connection portion to the stapling means; and
an urging means for urging the cable toward the inner side of the stapling means.

2. The sheet processing apparatus according to claim 1, wherein the urging means is made of a wire spring having elasticity.

3. The sheet processing apparatus according to claim 2, wherein the wire spring is coupled to a metal portion of the apparatus and is structured for grounding the stapling means.

4. The sheet processing apparatus according to claim 1, wherein the stapling means is exposed to the exterior of the apparatus at the replacement portion.

5. The sheet processing apparatus according to claim 1, wherein the stapling means also serves as the outside of a housing of the apparatus.

6. The sheet processing apparatus according to claim 1, further comprising a paper jam treating means disposed adjacent to the stapling means on a sheet conveyance path at the apparatus so as to be open and closed for removing a jamming sheet,
wherein the apparatus stops its operation when the stapling means is located at other than the operation position or when the paper jam treating means is other than the closing state.

7. The sheet processing apparatus according to claim 1, further comprising an intermediate stacking portion for temporarily stacking the sheets to be conveyed, and an aligning means for aligning the sheets stacked on the intermediate stacking portion.

8. The sheet processing apparatus according to claim 1, wherein the stapling means is maintained by a predetermined amount of force at the operation position and the replacement position.

9. The sheet processing apparatus according to claim 1, wherein stapling means is movable by rotational movement between the operation position and the replacement position.

10. A sheet processing apparatus having a stapling means disposed detachably for stapling to conveyed sheets,
the stapling means being movably supported between an operation position for stapling to a conveyed sheet and a replacement position for detaching the stapling means from the apparatus, the stapling means comprising:
a connection portion connected to the apparatus for receiving a control signal from the apparatus;
a cable for transmitting the control signal from the connection portion to the stapling means; and
a bobbin for winding the cable inside the stapling means,
wherein the cable is unwound around the bobbin where the stapling means is located at the replacement position and is wound around the bobbin more as the stapling means moves closer to the operation position.

11. The sheet processing apparatus according to claim 10, wherein the stapling means is exposed to the exterior of the apparatus at the replacement portion.

12. The sheet processing apparatus according to claim 10, wherein the stapling means also serves as the outside of a housing of the apparatus.

13. The sheet processing apparatus according to claim 10, further comprising a paper jam treating means disposed adjacent to the stapling means on a sheet conveyance path at the apparatus so as to be open and closed for removing a jamming sheet,
wherein the apparatus stops its operation when the stapling means is located at other than the operation position or when the paper jam treating means is other than the closing state.

14. The sheet processing apparatus according to claim 10, further comprising an intermediate stacking portion for temporarily stacking the sheets to be conveyed, and an aligning means for aligning the sheets stacked on the intermediate stacking portion.

15. The sheet processing apparatus according to claim 10, wherein the stapling means is maintained by a predetermined amount of force at the operation position and the replacement position.

16. The sheet processing apparatus according to claim 10, wherein stapling means is movable by rotational movement between the operation position and the replacement position.

17. A sheet processing apparatus having a stapling means disposed detachably for stapling to conveyed sheets,
the stapling means being movably supported between an operation position for stapling to a conveyed sheet and a replacement position for detaching the stapling means from the apparatus: a connection portion, the stapling means comprising:
a connection portion connected to the apparatus for receiving a control signal from the apparatus; and
a cable for transmitting the control signal from the connection portion to the stapling means;
wherein the cable is wound in a spiral shape where the stapling means is located at the operation position and can be extended linearly more as the stapling means moves closer to the replacement position.

18. The sheet processing apparatus according to claim 17, wherein the stapling means is exposed to the exterior of the apparatus at the replacement portion.

19. The sheet processing apparatus according to claim 17, wherein the stapling means also serves as the outside of a housing of the apparatus.

20. The sheet processing apparatus according to claim 17, further comprising a paper jam treating means disposed adjacent to the stapling means on a sheet conveyance route so as to be open and closed at the apparatus for removing a jamming sheet,
wherein the apparatus stops its operation when the stapling means is located at other than the operation position or when the paper jam treating means is other than the closing state.

21. The sheet processing apparatus according to claim 17, further comprising an intermediate stacking portion for temporarily stacking the sheets to be conveyed, and an aligning means for aligning the sheets stacked on the intermediate stacking portion.

22. The sheet processing apparatus according to claim 17, wherein the stapling means is maintained by a predetermined amount of force at the operation position and the replacement position.

23. The sheet processing apparatus according to claim 17, wherein stapling means is movable by rotational movement between the operation position and the replacement position.

24. An image forming apparatus comprising:
an image forming section for forming an image on a sheet; and
a sheet processing apparatus for processing the sheet on which the image is formed at the image forming section,
wherein the sheet processing apparatus is as set forth in any of claims 1 to 23.
